(19) United States
(12) Patent Application Publication
(10) Pub. No.: US 2009/0056845 A1
(43) Pub. Date: Mar. 5, 2009

(54) RUBBER COMPOSITION AND TIRE HAVING COMPONENT CONTAINING COMBINATION OF EMULSION SBR AND TACKIFYING RESIN

(76) Inventors: Paul Harry Sandstrom, Cuyahoga Falls, OH (US); Gregory Martin Holtzapple, Kent, OH (US); Brad Stephen Gulas, Cleveland, OH (US)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 11/845,127

(22) Filed: Aug. 27, 2007

(51) Int. Cl. C08K 13/00; B60C 1/00

(52) U.S. Cl. 152/151; 524/526

(57) ABSTRACT

This invention relates to a tire with a sidewall composition comprised of a combination of emulsion polymerization prepared styrene/butadiene rubber (referred to herein as emulsion SBR or E-SBR), an alkylphenol/acetylene based tackifying resin, cis 1,4-polybutadiene rubber and a controlled minor amount of cis 1,4-polyisoprene rubber, preferably natural rubber.

### FIELD OF THE INVENTION

This invention relates to a tire with a sidewall composition comprised of a combination of emulsion polymerization prepared styrene/butadiene rubber (referred to herein as emulsion SBR or E-SBR), an alkylphenol/acetylene based tackifying resin, cis 1,4-polybutadiene rubber and a controlled minor amount of cis 1,4-polyisoprene rubber, preferably natural rubber.

### BACKGROUND OF THE INVENTION

A natural rubber-based tire sidewall composition may typically be composed of elastomers including, for example, a significant content of natural rubber (natural cis 1,4-polyisoprene) together with cis 1,4-polybutadiene rubber (a synthetic rubber).

A significant challenge is presented of replacing a significant portion of the natural rubber in such tire sidewall rubber composition.

A motivation for such challenge is a desire for a natural rubber alternative, at least a partial alternative, in a form of a synthetic rubber such as emulsion polymerization prepared styrene/butadiene rubber (which may be referred to herein as emulsion SBR or E-SBR) to offset relative availability and/or cost considerations of natural rubber.

However, replacement of a significant portion of the natural rubber in such natural rubber based tire sidewall composition is not a simple matter and requires more than routine experimentation, particularly where it is desired to provide the uncured rubber composition with suitable building tack.

Indeed, it has been observed that the presence of significant amounts of emulsion SBR in combination with only a minimal amount, or a total replacement of, natural rubber in a natural rubber based rubber composition, can significantly reduce building tack for the uncured rubber composition.

It has further been observed that an addition of alkylphenol/formaldehyde based tackifying resins to such rubber composition did not sufficiently provide suitable building tack for such uncured rubber composition.

Accordingly, for this invention, rubber compositions were evaluated, from a building tack viewpoint for the uncured rubber composition, which contained various tackifying resins, including a specific alkylphenol/acetylene tackifying resin, with a combination of cis 1,4-polybutadiene rubber, emulsion SBR and only a low level, if any, of natural rubber.

In the description of this invention, the terms “compounded” rubber compositions and “compounds”, where used refer to the respective rubber compositions which have been compounded with appropriate compounding ingredients such as, for example, carbon black, oil, stearic acid, zinc oxide, silica, wax, antidegradants, resin(s), sulfur and accelerator(s) and silica and silica coupler where appropriate. The terms “rubber” and “elastomer” may be used interchangeably. The amounts of materials are usually expressed in parts of material per 100 parts of rubber polymer by weight (phr).

### DISCLOSURE AND PRACTICE OF THE INVENTION

In accordance with this invention, a (uncured) rubber composition is comprised of, based upon parts by weight per 100 parts by weight rubber (phr):

(A) 100 phr of diene-based elastomers comprised of:
(1) from about 5 to about 15 phr of cis 1,4-polyisoprene rubber comprised of at least one of natural and synthetic cis 1,4-polyisoprene rubber, preferably natural rubber;
(2) from about 55 to about 75 phr of cis 1,4-polybutadiene rubber,
(3) from about 10 to about 30 phr of emulsion polymerization prepared styrene/butadiene rubber (E-SBR);

(B) from about 3 to about 10 phr of alkylphenol/acetylene tackifying resin; and

(C) from about 20 to about 120, alternately from about 45 to about 90, phr of particulate reinforcing filler comprised of:
(1) rubber reinforcing carbon back, or
(2) about 10 to about 80, alternately from about 30 to about 60, phr of rubber reinforcing carbon black, and up to about 50, alternately from about 10 to about 50, alternately from about 15 to about 30, phr of amorphous synthetic silica, preferably precipitated silica; and

wherein at least one surface of said rubber composition contains said alkyphenol/acetylene tackifying resin.

In practice, said alkylphenol/acetylene tackifying resin is preferably a para tertiary butylphenol/acetylene tackifying resin.

Representative of a para tertiary butylphenol/acetylene resin is, for example, Koresin from BASF.

In practice said silica is usually used in combination with a silica coupler for said silica having a moiety reactive with hydroxyl groups (e.g. silanol groups) on said silica and another different moiety interactive with said diene-based elastomer(s).

In one aspect of the invention, said particulate rubber reinforcement is rubber reinforcing carbon black.

In another aspect of the invention, said particulate rubber reinforcement is comprised of a combination of rubber reinforcing carbon black and amorphous silica, particularly precipitated silica.

The alkylphenol/acetylene based tackifying resin itself is not intended to include alkylphenol/formaldehyde resins, although the alkylphenol/acetylene based tackifying resin may be used together with alkylphenol/formaldehyde tackifying resins if desired and if appropriate.

The such alkylphenol/formaldehyde tackifying resins are, for example those in which the alkylphenol is para tertiary octylphenol or para tertiary butylphenol, usually the para tertiary octylphenol.

Representative of such more somewhat often used alkylphenol/formaldehyde tackifying resins is, for example, SP-1068™ from the SI Group which might be described as an unreactive para tertiary octylphenol/formaldehyde based tackifying resin.

In further accordance with this invention, a sulfur cured rubber composition is provided by sulfur curing said uncured rubber composition which contains said alkylphenol/acetylene tackifying resin on its surface.

Accordingly, a sulfur cured rubber composition is provided.

In additional accordance with this invention, said uncured tire rubber component, for example an uncured sidewall rubber component, is provided wherein at least one surface thereof contains said alkylphenol/acetylene tackifying resin.

In further accordance with this invention, an uncured rubber composition for an uncured rubber tire component, such as for example a tire rubber sidewall component, is comprised of said uncured rubber composition having a surface containing said alkylphenol/acetylene tackifying resin.

In additional accordance with this invention, a sulfur cured rubber composition, for example a sidewall rubber component is provided by sulfur curing said uncured rubber component which contains said alkylphenol/acetylene tackifying resin on its surface.

In additional accordance with this invention, an assembly of uncured rubber tire components is provided which contains said uncured rubber component, for example said tire sidewall rubber component, wherein said uncured rubber component (e.g. sidewall rubber component) has a surface with suitable building tack for building said uncured rubber component, for example the tire sidewall rubber component, into an assembly of uncured rubber tire components.

In further accordance with this invention an assembly of uncured rubber tire components is provided wherein said uncured tire component (e.g. tire sidewall rubber component) is adhered to at least one other uncured tire rubber component by surface tack provided by said alkylphenol/acetylene tackifying resin on the surface of said uncured tire rubber component (wherein at least one of said components such as said tire sidewall rubber component contains said alkylphenol/acetylene tackifier resin on its interfacial surface).

A cured rubber tire is provided by curing (sulfur curing) said assembly of uncured rubber components, wherein at least one of said rubber components contains said alkylphenol/acetylene tackifying resin on its interfacial surface (surface between said rubber component and at least one other rubber component of the tire) in a suitable mold to form a cured rubber tire.

A cured rubber tire is provided in a form of a cured assembly (sulfur cured assembly) of said uncured tire components (e.g. tire rubber sidewall, particularly where at least one of said components is a tire rubber sidewall component having said alkylphenol/acetylene tackifying resin on its interfacial surface).

Accordingly, a cured rubber tire is provided having a cured rubber sidewall component comprised of the rubber composition of this invention with an alkylphenol/acetylene tackifying resin on its interfacial surface between said sidewall component and another tire rubber component.

A significant aspect of the invention is the inclusion of the alkylphenol/acetylene tackifying resin, particularly the para tertiary butylphenol/acetylene resin, within and on a surface of the aforesaid rubber composition, particularly the tire sidewall component composed of said rubber composition, to promote building tack for the uncured rubber surface.

This is considered herein to be significant in a sense of being able to promote, or provide, surface building tack for the uncured rubber component during the building of the rubber component into an assembly of tire rubber components prior to the curing step for the tire assembly.

For the reinforcing filler, the silica (e.g. precipitated silica), if used, may be used to the exclusion of, or optionally, and if desired, used in conjunction with a silica coupler to couple the silica to the elastomer(s), to thus enhance its effect as reinforcement for the elastomer composition. Use of silica couplers for such purpose are well known and typically have a moiety reactive with hydroxyl groups (e.g. silanol groups) on the silica and another moiety interactive with the elastomer(s) to create the silica-to-rubber coupling effect.

As hereinbefore mentioned, a coupling agent may, if desired, be utilized with the silica to aid in its reinforcement of the rubber composition which contains the silica. Such coupling agent conventionally contains a moiety reactive with hydroxyl groups on the silica (e.g. precipitated silica) and another and different moiety interactive with the diene hydrocarbon based elastomer.

In practice, said coupling agent for said optional silica reinforcement, if used, may be, for example,

(A) a bis-(3-triakloxysilylalkyl)polysulfide such as, for example, a bis-(3-triethoxysilylpropyl) polysulfide, having an average of from 2 to about 4 and more preferably an average of from 2 to about 2.6 or from about 3.4 to about 4, connecting sulfur atoms in its polysulfidic bridge, or

(B) a bis-(3-triethoxysilylpropyl)polysulfide having an average of from about 2 to about 2.6 connecting sulfur atoms in its polysulfidic bridge or a bis-(3-triethoxysilylpropyl)polysulfide having an average of from about 3.4 to about 4 connecting sulfur atoms in its polysulfidic bridge, wherein said polysulfide having an average of from 2 to about 2.6 connecting sulfur atoms in its polysulfidic bridge (to the exclusion of such polysulfide having an average of from 3 to 4 connecting sulfur atoms in its polysulfidic bridge) is blended with said rubber composition in the absence of sulfur and sulfur vulcanization accelerator and wherein said polysulfide having an average of from about 3.4 to about 4 connecting sulfur atoms in its polysulfidic bridge is thereafter blended with said rubber composition in the presence of sulfur and at least one sulfur vulcanization accelerator, or

(C) an organoalkoxymercaptosilane composition of the general Formula (I) represented as:

(X)ₙ(R₇O)₃₋ₙ—Si—R₈—SH (I)

wherein X is a radical selected from a halogen, namely chlorine or bromine and preferably a chlorine radical, and from alkyl radicals having from one to 16, preferably from one through 4, carbon atoms, preferably selected from methyl, ethyl, propyl (e.g. n-propyl) and butyl (e.g. n-butyl) radicals; wherein R₇ is an alkyl radical having from 1 through 18, alternately 1 through 4, carbon atoms preferably selected from methyl and ethyl radicals and more preferably an ethyl radical; wherein R₈ is an alkylene radical having from one to 16, preferably from one through 4, carbon atoms, preferably a propylene radical; and n is an average value of from zero through 3, preferably zero, and wherein, in such cases where n is zero or 1, R₇ may be the same or different for each (R₇O) moiety in the composition, and

(D) said organolkoxyomercaptosilane of the general Formula (I) capped with a moiety which uncaps the organoalkoxymercaptosilane upon heating to an elevated temperature.

Representative examples of various organoalkoxymercaptosilanes are, for example, triethoxy mercaptopropyl silane, trimethoxy mercaptopropyl silane, methyl dimethoxy mercaptopropyl silane, methyl diethoxy mercaptopropyl silane, dimethyl methoxy mercaptopropyl silane, triethoxy mercaptoethyl silane, tripropoxy mercaptopropyl silane, ethoxy dimethoxy mercaptopropylsilane, ethoxy diisopropoxy mercaptopropylsilane, ethoxy didodecyloxy mercaptopropylsilane and ethoxy dihexadecyloxy mercaptopropylsilane.

Such organoalkoxymercaptosilanes may be capped with various moieties as discussed above.

A representative example of a capped organoalkoxymercaptosilane coupling agent useful for this invention is a liquid 3-octanoylthio-1-propyltriethoxysilane as an NXT™ Silane from Momentive Performance Materials, formerly GE Silicones, as well as organomercaptosilane oligomers from Momentive Performance Materials.

The coupling agent may, for example, be added directly to the elastomer mixture or may be added as a composite of precipitated silica and such coupling agent formed by treating a precipitated silica therewith or by treating a colloidal silica therewith and precipitating the resulting composite.

For example, said optional silica (e.g. precipitated silica), or at least a portion of said optional silica, may be pre-treated prior to addition to said elastomer(s):

(A) with an alkylsilane of the general Formula (II), or

(B) with said bis(3-triethoxysilylpropyl)polysulfide having an average of from about 2 to about 4 connecting sulfur atoms in its polysulfidic bridge, or

(C) with an organomercaptosilane such as, for example, said organomercaptosilane of the general Formula (I), or

(D) with a combination of said alkylsilane of general Formula (I) and said bis(3-triethoxysilylpropyl)polysulfide having an average of from about 2 to about 4 connecting sulfur atoms in its polysulfidic bridge, or

(E) with a combination of said alkylsilane of general Formula (II) and said organomercaptosilane;

wherein said alkylsilane of the general Formula (I) is represented as:

Xₙ—Si—R₆₍₄₋ₙ₎ (II)

wherein R₆ is an alkyl radical having from 1 to 18 carbon atoms, preferably from 1 through 4 carbon atoms; n is a value of from 1 through 3; X is a radical selected from the group consisting of halogens, preferably chlorine, and alkoxy groups selected from methoxy and ethoxy groups, preferably an ethoxy group.

A significant consideration for said pre-treatment of said silica is to reduce, or eliminate, evolution of alcohol in situ within the rubber composition during the mixing of the silica with said elastomer such as may be caused, for example, by reaction such coupling agent contained within the elastomer composition with hydroxyl groups (e.g. silanol groups) contained on the surface of the silica.

Representative of additional synthetic diene based elastomers for said tire sidewall rubber composition are, for example, synthetic cis 1,4-polyisoprene rubber and solution polymerization prepared styrenelbutadiene copolymer rubber (S-SBR).

It is readily understood by those having skill in the art that the rubber compositions would be compounded by methods generally known in the rubber compounding art, such as mixing the various sulfur-vulcanizable constituent rubbers with various commonly used additive materials such as, for example, curing aids, such as sulfur, activators, retarders and accelerators, processing additives, such as oils, the aforesaid optional silica, and plasticizers, fillers, pigments, fatty acid, zinc oxide, microcrystalline waxes, antioxidants and antiozonants, peptizing agents and carbon black reinforcing filler. As known to those skilled in the art, depending on the intended use of the sulfur vulcanizable and sulfur-vulcanized material (rubbers), the additives mentioned above are selected and commonly used in conventional amounts.

The vulcanization is conducted in the presence of a sulfur-vulcanizing agent. Examples of suitable sulfur vulcanizing agents include elemental sulfur (free sulfur) or sulfur donating vulcanizing agents, for example, an amine disulfide, polymeric polysulfide or sulfur olefin adducts. Preferably, the sulfur-vulcanizing agent is elemental sulfur.

Accelerators are used to control the time and/or temperature required for vulcanization and to improve the properties of the vulcanizate. In one embodiment, a single accelerator system may be used, i.e., primary accelerator. In another embodiment, combinations of two or more accelerators in which the primary accelerator is generally used in the larger amount, and a secondary accelerator which is generally used in smaller amounts in order to activate and to improve the properties of the vulcanizate. Combinations of these accelerators have been known to produce a synergistic effect on the final properties and are somewhat better than those produced by use of either accelerator alone. In addition, delayed action accelerators may be used which are not affected by normal processing temperatures but produce satisfactory cures at ordinary vulcanization temperatures. Suitable types of accelerators that may be used in the present invention are amines, disulfides, guanidines, thioureas, thiazoles, thiurams, sulfenamides, dithiocarbamates and xanthates. Preferably, the primary accelerator is a sulfenamide. If a second accelerator is used, the secondary accelerator is preferably a guanidine, dithiocarbamate or thiuram compound.

The tire can be built, shaped, molded and cured by various methods which will be readily apparent to those having skill in such art.

The invention may be better understood by reference to the following example in which the parts and percentages are by weight unless otherwise indicated.

### EXAMPLE I

Experiments were conducted to evaluate the feasibility of providing a rubber composition with elastomers composed of emulsion SBR (E-SBR) and cis 1,4-polybutadiene rubber, without including natural rubber (natural cis 1,4-polyisoprene rubber), together with various tackifying resins to promote building back for the uncured rubber composition.

Rubber Samples B through D were prepared comprised of the aforesaid E-SBR and cis 1,4-polybutadiene elastomers together with, individually, three different tackifying resins.

Rubber Sample A (Control Sample A) is a rubber composition containing elastomers composed of a significant amount of natural rubber (40 phr) together with a cis 1,4-polybutadiene rubber for which the rubber composition contains a relatively common alkylphenol/formaldehyde tackifying resin to provide building tack for the uncured rubber composition.

The rubber composition samples were prepared by mixing the elastomers(s) together with reinforcing fillers and other rubber compounding ingredients in a first non-productive mixing stage (NP) in an internal rubber mixer for about 4 minutes to a temperature of about 160° C. The resulting mixture is then mixed in a productive mixing stage (P) in an internal rubber mixer with sulfur curative for about 2 minutes to a temperature of about 115° C. The rubber composition is cooled to below 40° C. between the non-productive mixing step and the productive mixing step.

The basic formulation for the rubber samples is presented in the following Table 1 expressed in parts by weight per 100 parts of rubber unless otherwise indicated.

TABLE 1

| | Samples | |
|---|---|---|
| | Control | |
| | A | B-D |
| First Non-Productive Mixing Step | | |
| (Mixed to about 160° C.) | | |
| Natural cis 1,4-polyisoprene rubber (TRS 20) | 40 | 0 |
| Cis 1,4-polybutadiene rubber¹ | 60 | 65 |
| E-SBR rubber² | 0 | 35 |
| Carbon black³ | 51 | 45 |
| Processing oil and wax | 14 | 14 |
| Fatty acid⁴ | 1 | 1 |
| Antioxidant and antiozonant⁵ | 4.5 | 4.5 |
| Tackifiers (Tackifiers X, Y or Z) | 4 | 4 |
| Productive Mixing Step (Mixed to about 115° C.) | | |
| Zinc oxide | 3 | 3 |
| Sulfur and accelerator(s)⁶ | 2.5 | 2.5 |

Tackifier X - octylphenol/formaldehyde resin as SP1068 from Schenectady
Tackifier Y - vinyl monomer modified alkylphenol/formaldehyde resin as Elaztobond T-3100 from SI Group
Tackifier Z - para-tertiary butylphenol/acetylene resin as Koresin from BASF
¹As BUD1207 ™ from The Goodyear Tire & Rubber Company
²As PLF1502 ™ from The Goodyear Tire & Rubber Company
³N550, a rubber reinforcing carbon black
⁴Primarily stearic acid (at least 90 percent by weight stearic acid)
⁵Amine and quinoline types
⁶Sulfenamide and quanidine types

The following Table 2 illustrates cure behavior and various physical properties of rubber compositions based upon the basic recipe of Table 1 and reported herein as a Comparative (or Control) Sample A and Samples B through D. Where cured rubber samples are examined, such as for the stress-strain, hot rebound and hardness values, the rubber samples were cured for about 12 minutes at a temperature of about 170° C.

TABLE 2

| | Samples (phr) | | | |
|---|---|---|---|---|
| | Control | | | |
| | A | B | C | D |
| Natural cis 1,4-polyisoprene rubber | 40 | 0 | 0 | 0 |
| Cis 1,4-polybutadiene rubber | 60 | 65 | 65 | 65 |
| E-SBR rubber | 0 | 35 | 35 | 35 |
| Tackifying resin X | 4 | 4 | 0 | 0 |
| Tackifying resin Y | 0 | 0 | 4 | 0 |
| Tackifying resin Z | 0 | 0 | 0 | 4 |
| Rheometer, 150° C. | | | | |
| Maximum torque, dNm | 10.6 | 10.6 | 10.5 | 11.2 |
| Minimum torque, dNm | 2.3 | 1.8 | 1.7 | 1.8 |
| Delta torque, dNm | 8.3 | 8.8 | 8.8 | 9.4 |
| T90, minutes | 11 | 11.4 | 11.2 | 10.5 |
| Stress-strain¹ | | | | |
| Tensile strength (MPa) | 13.9 | 12 | 11.4 | 11.9 |
| Elongation at break (%) | 716 | 755 | 724 | 692 |
| 300% modulus (MPa) | 4.4 | 3.8 | 3.8 | 4.3 |
| Rebound | | | | |
| 23° C. | 55 | 52 | 53 | 53 |
| 100° C. | 59 | 56 | 56 | 57 |
| Shore A hardness | | | | |
| 23° C. | 51 | 53 | 52 | 54 |
| 100° C. | 45 | 46 | 46 | 48 |
| Tear Strength, N, 95° C. | 157 | 187 | 154 | 139 |
| Tack Strength, N, of Uncured Rubber | | | | |
| Samples² | | | | |
| Original | 8.4 | 0.7 | 1.5 | 0.9 |
| Aged 5 days at 23° C. in air | 8.1 | 0.5 | 0.8 | 0.4 |
| Static Ozone Test Observations of | | | | |
| Cured Rubber Samples, | | | | |
| Ozone 50 pphm, 48 hours, 40° C., | | | | |
| Variable Strain | | | | |
| Number of cracks | B | 0 | 0 | 0 |
| Size of cracks | 2 | N/A | N/A | N/A |
| Dynamic ozone test observations of | | | | |
| cured rubber Samples, Ozone 50 pphm, | | | | |
| 48 hours, 40° C., 60% Strain | | | | |
| Number of cracks | D | D | D | D |
| Size of cracks | 2 | 2 | 2 | 2 |

¹Data according to Automated Testing System instrument by the Instron Corporation which incorporates six tests in one system. Such instrument may determine ultimate tensile, ultimate elongation, modulii, etc. Data reported in the Table is generated by running the ring tensile test station which is an Instron 4201 load frame.
²According to a positive pressure tack test for interfacial tack between two uncured rubber samples by pulling apart two uncured rubber samples at ambient room temperature (e.g. 23° C.) which had been pressed together with a pressure of 0.2 MPa (30 psi) for 30 seconds following which the pressure is released. The force to pull the samples apart is measured in terms of Newtons (N) force.

| Number of Cracks | Size of Cracks |
|---|---|
| O = None | 1 = small (hairline) |
| A = less than ¼ of the surface | 2 = medium |
| B = ¼ to ½ of the surface | 3 = large |
| C = ½ to ¾ of the surface | 4 = severe (open) |
| D = ¾ to all of the surface | |

It can be seen from Table 2 that both the original and aged surface tack strength for all of Samples B, C and D (without the natural rubber) were extremely low (ranging from 0.4 to 1.5 Newtons) as compared to the Control Sample A (ranging from 8.1 to 8.4 Newtons) which contained 40 phr of natural rubber and cis 1,4-polybutadiene rubber. The surface tack strength (building tack) for Samples B through D is considered herein to be unacceptably low for tire components to be used to build an assembly of rubber components for a tire.

Accordingly, it is concluded by this Example, that the rubber Samples which contained no natural rubber, together with the inclusion of the E-SBR and tackifying resins X, Y or Z, were inappropriate to provide sufficient original and aged tack for the uncured rubber Samples.

### EXAMPLE II

Experiments were conducted to evaluate use of adding back a low level of 10 phr (as compared to 40 phr) of natural rubber and 20 phr of E-SBR together with tackifying resins X, Y or M (a piperylene hydrocarbon based tackifying resin) for providing rubber Samples with surface building tack (tack strength).

Rubber Sample E (a Control rubber Sample) was similar to Control Rubber Sample A of Example I which contained 40 phr of natural rubber and tackifying resin X as the alkylphenol/formaldehyde tackifying resin without the E-SBR rubber.

Rubber Samples F, G and H contained 10 phr of natural rubber and E-SBR to replace a portion of the natural rubber together with the various tackifying resins X, Y or M (the piperylene-based hydrocarbon resin).

The rubber Samples were prepared in the manner of Example I.

The basic formulation for the rubber samples is presented in the following Table 3 expressed in parts by weight per 100 parts of rubber unless otherwise indicated.

TABLE 3

| | Control | | | |
|---|---|---|---|---|
| | E | F | G | H |
| Non-Productive Mixing | | | | |
| (about 4 minutes to about 150° C.) | | | | |
| Natural cis 1,4-polyisoprene rubber | 40 | 10 | 10 | 10 |
| Cis 1,4-polybutadiene rubber | 60 | 70 | 70 | 70 |
| E-SBR rubber | 0 | 20 | 20 | 20 |
| Carbon black | 51 | 45 | 45 | 45 |
| Antoxidants/Antiozonants | 5 | 5 | 5 | 5 |
| Processing oil and wax | 15 | 15 | 15 | 15 |
| Tackifying resin X | 3.5 | 3.5 | 0 | 0 |
| Tackifying resin Y | 0 | 0 | 0 | 3.5 |
| Tackifying resin M¹ | 0 | 0 | 3.5 | 0 |
| Productive Mixing | | | | |
| (mixed to about 115° C.) | | | | |
| Zinc oxide | 3 | 3 | 3 | 3 |
| Sulfur and accelerators | 2.5 | 2.5 | 2.5 | 2.5 |

¹Hydrocarbon resin based on piperylene as Piccotac ™ 1100 resin from Eastman Chemical Company

The following Table 4 illustrates cure behavior and various physical properties of rubber compositions based upon the basic recipe of Table 3 and reported herein for rubber Samples E through H.

TABLE 4

| | Samples | | | |
|---|---|---|---|---|
| | Control | | | |
| | E | F | G | H |
| Natural cis 1,4-polyisoprene rubber | 40 | 10 | 10 | 10 |
| Cis 1,4-polybutadiene rubber | 60 | 70 | 70 | 70 |
| E-SBR rubber | 0 | 20 | 20 | 20 |
| Tackifying resin X | 3.5 | 3.5 | 0 | 0 |
| Tackifying resin Y | 0 | 0 | 0 | 3.5 |
| Tackifying resin M¹ | 0 | 0 | 3.5 | 0 |
| Rheometer, 150° C. | | | | |
| Maximum torque, dNm | 10.4 | 10.3 | 11.4 | 10.4 |
| Minimum torque, dNm | 2.5 | 1.8 | 1.9 | 1.7 |
| Delta torque, dNm | 7.9 | 8.5 | 9.5 | 8.7 |
| T90, minutes | 11.0 | 8.5 | 7.8 | 8.7 |
| Stress-strain² | | | | |
| Tensile strength (MPa) | 13.9 | 11.6 | 11.2 | 11.8 |
| Elongation at break (%) | 710 | 698 | 624 | 705 |
| 300% modulus (MPa) | 4.2 | 3.8 | 4.3 | 3.7 |
| Rebound | | | | |
| 23° C. | 54 | 55 | 57 | 55 |
| 100° C. | 57 | 58 | 61 | 58 |
| Shore A hardness | | | | |
| 23° C. | 49 | 50 | 51 | 50 |
| 100° C. | 45 | 45 | 47 | 45 |
| Tear Strength, N, 95° C. | 172 | 133 | 109 | 152 |
| Tack Strength, N, of Uncured | | | | |
| Rubber Samples | | | | |
| Original | 7.8 | 1.2 | 1.5 | 2.8 |
| Aged 5 days at 23° C. in air | 13.5 | 0.8 | 2.1 | 1.7 |
| Static Ozone Test Observations of | | | | |
| Cured Rubber Samples, Ozone 50 pphm, | | | | |
| 48 hours, 40° C., Variable Strain | | | | |
| Number of cracks | B | 0 | C | 0 |
| Size of cracks | 1 | 0 | 2 | 0 |
| Dynamic ozone test observations of | | | | |
| cured rubber Samples, Ozone 50 pphm, | | | | |
| 48 hours, 40° C., 60% Strain | | | | |
| Number of cracks | D | D | D | D |
| Size of cracks | 2 | 2 | 2 | 2 |

From Table 4 it can be seen that the surface tack strength (building tack) for the rubber Samples F, G and H (ranging from 0.8 to 2.8 Newtons) containing 10 phr of natural rubber with an additional inclusion of the E-SBR with any of tackifying resins X, Y or M was extremely reduced as compared to the tack strength for Control rubber Sample E (ranging from 7.8 to 13.5 Newtons) which contained 40 phr of natural rubber without the E-SBR and contained tackifier resin X, an alkylphenol/formaldehyde tackifying resin.

Accordingly, it is concluded that a level of 10 phr of natural rubber together with the inclusion of the E-SBR with any of tackifying resins X, Y and M would be inappropriate for providing an uncured tire component (e.g. tire sidewall component) with sufficient building tack for building an assembly of rubber components for a tire.

### EXAMPLE III

Experiments were conducted to further evaluate use of a low level of 10 phr (as compared to 40 phr) of natural rubber, together with 20 phr of E-SBR and tackifying resins X, Y and Z (an alkylphenol/acetylene tackifying resin) for providing rubber Samples with surface building tack (tack strength).

Rubber Sample I (a Control rubber Sample) was similar to Control Rubber Sample A of Example I which contained 40 phr of natural rubber and tackifying resin X as the alkylphenol/formaldehyde tackifying resin without the E-SBR rubber.

Rubber Samples J, K and L contained 10 phr of natural rubber and 20 phr of E-SBR to replace a portion of the natural rubber together with the various tackifying resins X, Y or Z (the alkylphenol/acetylene tackifying resin).

The rubber Samples were prepared in the manner of Example I.

The basic formulation for the rubber samples is presented in the following Table 3 expressed in parts by weight per 100 parts of rubber unless otherwise indicated.

The rubber Samples were prepared in the manner of Example I.

The basic formulation for the rubber samples is presented in the following Table 5 expressed in parts by weight per 100 parts of rubber unless otherwise indicated.

TABLE 5

| | Control | | | |
|---|---|---|---|---|
| | I | J | K | L |
| Non-Productive Mixing | | | | |
| (4 minutes to about150° C.) | | | | |
| Natural cis 1,4-polyisoprene rubber | 40 | 10 | 10 | 10 |
| Cis 1,4-polybutadiene rubber | 60 | 70 | 70 | 70 |
| E-SBR rubber | 0 | 20 | 20 | 20 |
| Carbon black | 51 | 45 | 45 | 45 |
| Antoxidants/Antiozonants | 4.5 | 4.5 | 4.5 | 4.5 |
| Processing oil and wax | 14 | 14 | 14 | 14 |
| Tackifying resin X | 3.5 | 4 | 0 | 4 |
| Tackifying resin Y | 0 | 0 | 4 | 0 |
| Tackifying resin Z | 0 | 0 | 0 | 4 |
| Productive Mixing | | | | |
| (mixed to about 115° C.) | | | | |
| Zinc oxide | 3 | 3 | 3 | 3 |
| Sulfur and accelerators | 2.5 | 2.5 | 2.5 | 2.5 |

The following Table 6 illustrates cure behavior and various physical properties of rubber compositions based upon the basic recipe of Table 5 and reported herein for rubber Samples I through L.

TABLE 6

| | Samples | | | |
|---|---|---|---|---|
| | Control | | | |
| | I | J | K | L |
| Natural cis 1,4-polyisoprene rubber | 40 | 10 | 10 | 10 |
| Cis 1,4-polybutadiene rubber | 60 | 70 | 70 | 70 |
| E-SBR rubber | 0 | 20 | 20 | 20 |
| Tackifying resin X | 3.5 | 4 | 0 | 0 |
| Tackifying resin Y | 0 | 0 | 4 | 0 |
| Tackifying resin Z | 0 | 0 | 0 | 4 |
| Rheometer, 150° C. | | | | |
| Maximum torque, dNm | 11.0 | 10.8 | 12.2 | 12.3 |
| Minimum torque, dNm | 2.7 | 2.2 | 2.3 | 2.2 |
| Delta torque, dNm | 8.3 | 8.6 | 9.9 | 10.1 |
| T90, minutes | 10.6 | 8.8 | 8.2 | 8.0 |
| Stress-strain² | | | | |
| Tensile strength (MPa) | 13.8 | 13.1 | 13.3 | 13.3 |
| Elongation at break (%) | 720 | 761 | 708 | 700 |
| 300% modulus (MPa) | 4.1 | 3.9 | 4.4 | 4.3 |
| Rebound | | | | |
| 23° C. | 54 | 55 | 57 | 55 |
| 100° C. | 57 | 58 | 61 | 60 |
| Shore A hardness | | | | |
| 23° C. | 50 | 52 | 54 | 54 |
| 100° C. | 45 | 47 | 49 | 49 |
| Tear Strength, N, 95° C. | 195 | 191 | 177 | 154 |
| Tack Strength, N, of Uncured | | | | |
| Rubber Samples | | | | |
| Original | 7.9 | 3.0 | 5.6 | 5.2 |
| Aged 5 days at 23° C. in air | 11.2 | 2.7 | 3.1 | 5.7 |
| Aged 10 days at 23° C. in air | 12.8 | 0.7 | 0.8 | 7.9 |
| Static Ozone Test Observations of | | | | |
| Cured Rubber Samples, Ozone 50 pphm, | | | | |
| 48 hours, 40° C., Variable Strain | | | | |
| Number of cracks | 0 | 0 | 0 | 0 |
| Size of cracks | N/A | N/A | N/A | N/A |
| Dynamic ozone test observations of | | | | |
| cured rubber Samples, Ozone 50 pphm, | | | | |
| 48 hours, 40° C., 60% Strain | | | | |
| Number of cracks | D | D | C | C |
| Size of cracks | 3 | 3 | 2 | 2 |

From Table 6 it can be seen that the tack strength (surface building tack) for rubber Sample L (containing the alkylphenol/acetylene tackifying resin) was greatly improved over the tack strength of rubber Sample J (using tackifing resin X, namely the alkylphenol/formaldehyde resin) and rubber Sample K (using tackifying resin Y, namely the vinyl monomer modified alkylphenol/formaldehyde resin).

Moreover, the tack strength (5.2 to 7.9 Newtons) of rubber Sample L (tackifying resin Z) was sufficiently close to the tack strength (7.9 to 12.8 Newtons) of Control rubber Sample I that it is considered herein to be an appropriately useful building tack value.

Accordingly, it is concluded that a satisfactory building tack (surface tack strength) can be obtained for the rubber composition containing a relatively low level of 10 phr of natural rubber together with and E-SBR rubber and cis 1,4-polybutadiene rubber when using the alkylphenol/acetylene tackifying resin.

A composite including at least uncured rubber components is assembled in which a first uncured rubber component is composed of the rubber composition of Sample L which contained the alkylphenol/acetylene tackifying resin within and on its surface. The other uncured rubber component(s) did not have the alkylphenol/acetylene tackifying resin on its surface, although one or more of the other uncured rubber components may have had an alkylphenol/formaldehyde resin on its surface. It was observed that the building tack of the said first rubber component provided by the alkylphenol/acetylene tackifying resin was an adequate surface building tack to successfully build the composite assembly.

Accordingly, the composite assembly, which can be a tire assembly in which the said first uncured rubber component is a tire sidewall rubber component, is provided with the alkylphenol/acetylene tackifying resin on an interfacial surface between said first rubber component (e.g. the sidewall rubber component) and another uncured rubber component (e.g. another tire rubber component).

Upon curing the composite assembly (e.g. sulfur curing the assembly a cured assembly (e.g. cured rubber tire) is provided with an alkylphenol/acetylene tackifying resin on an interfacial surface between said first rubber component (e.g. tire sidewall component) and another tire rubber component.

While certain representative embodiments and details have been shown for the purpose of illustrating the invention, it w ill be apparent to those skilled in this art that various changes and modifications may be made therein without departing from the spirit or scope of the invention.

What it claimed is:

1. An uncured rubber composition is comprised of, based upon parts by weight per 100 parts by weight rubber (phr):
(A) 100 phr of diene-based elastomers comprised of:
(1) from about 5 to about 15 phr of cis 1,4-polyisoprene rubber comprised of at least one of natural and synthetic cis 1,4-polyisoprene rubber,
(2) from about 55 to about 75 phr of cis 1,4-polybutadiene rubber,
(3) from about 10 to about 30 phr of emulsion polymerization prepared styrene/butadiene rubber (E-SBR);
(B) from about 3 to about 10 phr of alkylphenol/acetylene tackifying resin; and
(C) from about 20 to about 120 phr of particulate reinforcing filler comprised of:
(1) rubber reinforcing carbon back, or
(2) about 10 to about 80 phr of rubber reinforcing carbon black, and up to about 50 phr of precipitated silica; and
wherein at least one surface of said rubber composition contains said alkyphenol/acetylene tackifying resin.

2. The rubber composition of claim 1 wherein said cis 1,4-polyisoprene rubber is natural rubber.

3. The rubber composition of claim 1 wherein said alkylphenol/acetylene tackifying resin is comprised of a para tertiary butylphenol/acetylene tackifying resin.

4. The rubber composition of claim 1 wherein said reinforcing filler is rubber reinforcing carbon black.

5. The rubber composition of claim 1 wherein said reinforcing filler is comprised of about 10 to about 80 phr of rubber reinforcing carbon black, and up to about 50 phr of precipitated silica.

6. The rubber composition of claim 1 wherein said reinforcing filler is comprised of about 10 to about 80 phr of rubber reinforcing carbon black, and from about 10 to about 50 phr of precipitated silica.

7. The rubber composition of claim 5 which further contains a silica coupler for said precipitated silica wherein said silica coupler has a moiety reactive with hydroxyl groups on said silica and another different moiety interactive with said diene-based elastomer(s).

8. The rubber composition of claim 6 which further contains a silica coupler for said precipitated silica wherein said silica coupler has a moiety reactive with hydroxyl groups on said silica and another different moiety interactive with said diene-based elastomer(s).

9. The rubber composition of claim 1 which further contains an alkylphenol/formaldehyde tackifying resin.

10. The rubber composition of claim 9 wherein said alkylphenol/formaldehyde tackifying resin is comprised of at least one of para tertiary octylphenol/formaldehyde tackifying resin and para tertiary butylphenol/formaldehyde tackifying resin.

11. A sulfur cured rubber composition of claim 1 which contains said alkylphenol/acetylene tackifying resin on its surface.

12. The rubber composition of claim 1 in a form of an uncured tire rubber component wherein at least one surface of said uncured tire rubber component contains said alkylphenol/acetylene tackifying resin on its surface.

13. The rubber composition of claim 12 in a form of a tire sidewall rubber component.

14. The rubber composition of claim 12 in a form of a sulfur cured tire rubber

15. The rubber composition of claim 13 in a form of a sulfur cured tire rubber sidewall component.

16. An assembly of uncured rubber tire components wherein one of said uncured tire components is the uncured rubber composition of claim 1 having a surface building tack provided by said alkylphenol/acetylene tackifying resin on its interfacial surface.

17. An assembly of uncured rubber tire components wherein one of said uncured tire components is an uncured tire sidewall rubber component comprised of the uncured rubber composition of claim 1 having a surface building tack provided by said alkylphenol/acetylene tackifying resin on its interfacial surface.

18. A cured rubber tire provided by curing the assembly of claim 16 in a suitable mold to form a cured rubber tire.

19. A cured rubber tire in a form of a cured assembly of claim 17.

20. A cured rubber tire having a cured rubber sidewall component comprised of the rubber composition of claim 1 with an alkylphenol/acetylene tackifying resin on its interfacial surface between said sidewall component and another tire rubber component.
